(19) United States
(12) Patent Application Publication
(10) Pub. No.: US 2014/0097273 A1
(43) Pub. Date: Apr. 10, 2014

(54) APPARATUS AND METHOD FOR FLUID DELIVERY

(71) Applicant: USAmist, Greensboro, NC (US)

(72) Inventors: Brandon Lowry Helms, Cornelius, NC (US); Robert Brian Groat, Greensboro, NC (US); Brad Forrest, Cary, NC (US)

(73) Assignee: USAmist, Greensboro, NC (US)

(21) Appl. No.: 14/046,610

(22) Filed: Oct. 4, 2013

Related U.S. Application Data
(60) Provisional application No. 61/709,795, filed on Oct. 4, 2012.

(51) Int. Cl. B05B 12/02

(52) U.S. Cl. CPC B05B 12/02
USPC 239/337

(57) ABSTRACT

An apparatus for delivering a mist from a fluid comprises a housing defining a reservoir for accommodating the fluid and a pump in fluid communication with the reservoir for drawing fluid from the reservoir. A fluid distribution system is in fluid communication with pump for transmitting fluid from the pump. A controller is provided, including a programmable digital processor for selectively operating the pump according to predetermined control parameters.

### CROSS-REFERENCES

This application is related to U.S. provisional application No. 61/709,795, filed Oct. 4, 2012, entitled “APPARATUS AND METHOD FOR FLUID DELIVERY”, naming Brandon Lowry Helms, Robert Brian Groat, and Brad Forrest as the inventors. The contents of the provisional application are incorporated herein by reference in their entirety, and the benefit of the filing date of the provisional application is hereby claimed for all purposes that are legally served by such claim for the benefit of the filing date.

### BACKGROUND

An apparatus and method is described for delivering a fluid as a spray from a fluid reservoir to a distribution system and, more particularly, a fluid delivery apparatus and method for programmable delivery of the spray at predetermined times and frequencies.

Mosquitoes and other flying insects and pests are a significant problem. Mosquitoes in particular can cause serious health problems. Diseases such as malaria, West Nile Virus and encephalitis are believed to be carried by mosquitoes, and such diseases are transferred when a mosquito breaks the skin. Personal sprays and citronella candles and torches are often used to combat mosquitoes and other pests, but their effectiveness is limited.

Integrated spraying systems for residential and commercial use have become more popular for mosquito and pest control. Conventional spraying systems typically consist of a 55-gallon drum containing dilute insecticide, a pump and a motor mounted on top of the drum, a programmable timer, and a distribution conduit placed along a lot line or other location so the insecticide can be distributed over a wide area. Holes are cut into the lid of the drum and function as a pump interface and air relief vents. In use, the pump draws fluid from the drum and transmits it to several spray nozzles dispersed along the conduit. Conduit runs from the pump for application of insecticide around the exterior of residential homes or commercial buildings.

Mosquito and other insect population and activity varies over time and environmental conditions. The application of proper amounts of insecticide at the proper times is difficult and cumbersome. Control of spray times, frequencies and volumes is the function of a programmed control system, which are generally not sophisticated enough to address important aspects of insect populations.

For the foregoing reasons, there is a need for an apparatus and method for fluid delivery as a spray for controlling pests. The new apparatus and method should provide a control system which allows a user to vary the application of insecticide in terms of time, frequency and volume. Further, the control system should allow for the application of a selected volume of insecticide for a selected period of time to respond to known or changing environmental or other conditions.

### SUMMARY

An apparatus for delivering a mist from a fluid comprises a housing defining a reservoir for accommodating the fluid and a pump in fluid communication with the reservoir for drawing fluid from the reservoir. A fluid distribution system is in fluid communication with pump for transmitting fluid from the pump. A controller is provided, including a programmable digital processor for selectively operating the pump according to predetermined control parameters.

### BRIEF DESCRIPTION OF THE DRAWINGS

For a more complete understanding of the present invention, reference should now be had to the embodiments shown in the accompanying drawings and described below. In the drawings:

FIG. 1 is a front right perspective view of an embodiment of an apparatus for fluid delivery.

FIG. 2 is a front elevation view of the apparatus as shown in FIG. 1.

FIG. 3 is a right side elevation view of the apparatus as shown in FIG. 1, the left side elevation view being a mirror image.

FIG. 4 is a right side elevation view of the apparatus as shown in FIG. 3 with a lid and a front panel removed.

FIG. 5 is a rear right perspective view of the apparatus as shown in FIG. 1.

FIG. 6 is a top plan view of the apparatus as shown in FIG. 1.

FIG. 7 is a top plan view of the apparatus as shown in FIG. 6 with the lid and the front panel removed.

FIG. 8 is a bottom plan view of the apparatus as shown in FIG. 1.

FIG. 9 is a front right perspective view of the apparatus as shown in FIG. 1 with the lid partially open.

FIG. 10 is a perspective view of the lid and front panel as a single piece for manufacture.

FIG. 11 is a front left perspective view of the apparatus for fluid delivery as shown in FIG. 7 with a controller and a pump and motor installed.

FIG. 12 is a front elevation view of the apparatus for fluid delivery as shown in FIG. 11.

FIG. 13 is a front right perspective cross-section view of the apparatus as shown in FIG. 9 taken along a line from front to rear.

FIG. 14 is a front right perspective cross-section view of the apparatus as shown in FIG. 9 taken along a line from side to side.

FIG. 15 is a close-up front right perspective view of the apparatus for fluid delivery as shown in FIG. 1 showing a hinge for the lid.

FIG. 16 is a close-up top plan view of the apparatus for fluid delivery as shown in FIG. 1 showing a rear portion of a top wall.

FIG. 17 is a close-up left side perspective view of the apparatus for fluid delivery as shown in FIG. 16 showing an opening in the top wall for fluid supply.

FIG. 18 is a close-up top plan view of the apparatus for fluid delivery as shown in FIG. 1 showing a slot and tab connection of the lid and the front access panel.

FIG. 19 is a close-up front left side perspective view of the apparatus for fluid delivery as shown in FIG. 1.

FIG. 20 is a close-up front elevation view of the apparatus for fluid delivery as shown in FIG. 1 showing a front side.

FIG. 21 is a close-up top perspective view of the apparatus for fluid delivery as shown in FIG. 1 with the front access panel removed and showing the pump and the motor.

FIG. 22 is a front elevation view of the apparatus for fluid delivery as shown in FIG. 21 with the lid raised.

FIG. 23 is a front perspective view of a motor for use in the apparatus for fluid delivery as shown in FIG. 1.

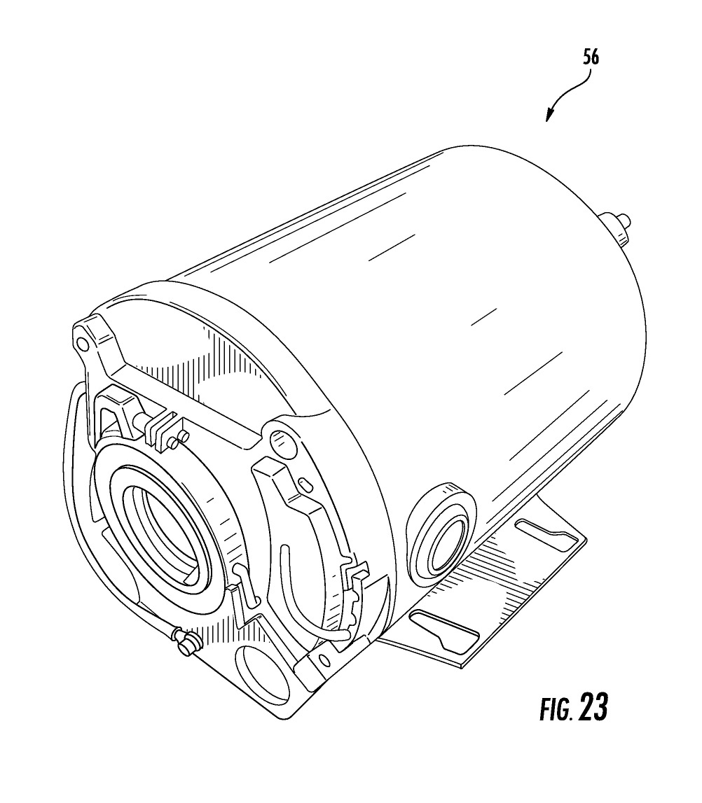

FIG. 24 is a rear perspective view of a pump fitting for use in the apparatus for fluid delivery as shown in FIG. 1.

FIG. 25 is a top perspective view of a float switch for use in the apparatus for fluid delivery as shown in FIG. 1.

FIG. 26 is a close-up front left perspective view of the apparatus for fluid delivery as shown in FIG. 1.

FIG. 27 is a close-up view of the apparatus for fluid delivery as shown in FIG. 1 showing the controller installed.

FIG. 28 is a close-up top plan view of the apparatus for fluid delivery as shown in FIG. 1 showing a power cord in the top wall.

FIG. 29 is a flow diagram of an embodiment of a method for fluid delivery.

### DESCRIPTION

Certain terminology is used herein for convenience only and is not to be taken as a limitation on the invention. For example, words such as “upper,” “lower,” “left,” “right,” “horizontal,” “vertical,” “upward,” and “downward” merely describe the configuration shown in the FIGs. Indeed, the components may be oriented in any direction and the terminology, therefore, should be understood as encompassing such variations unless specified otherwise.

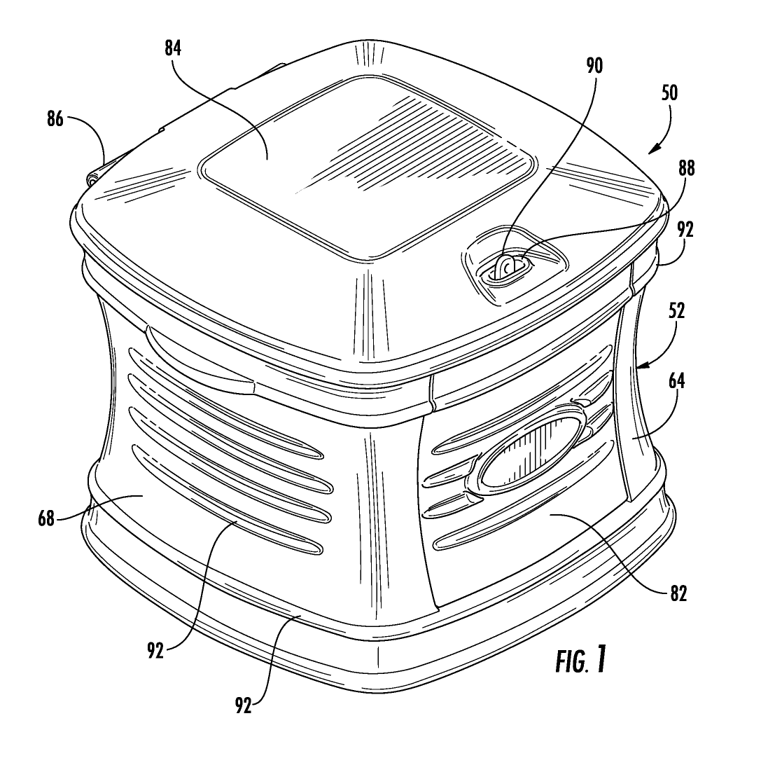

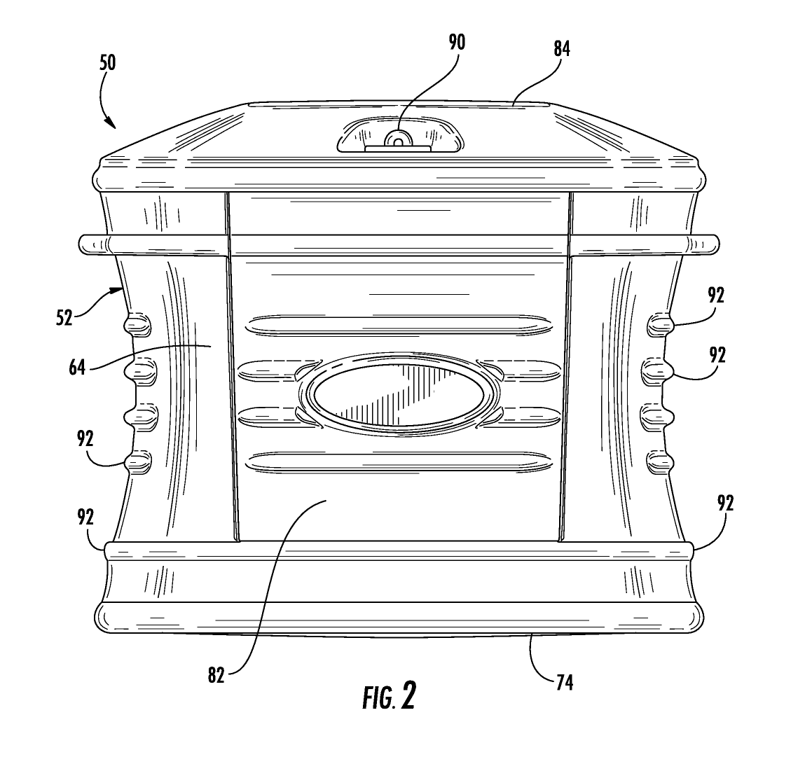

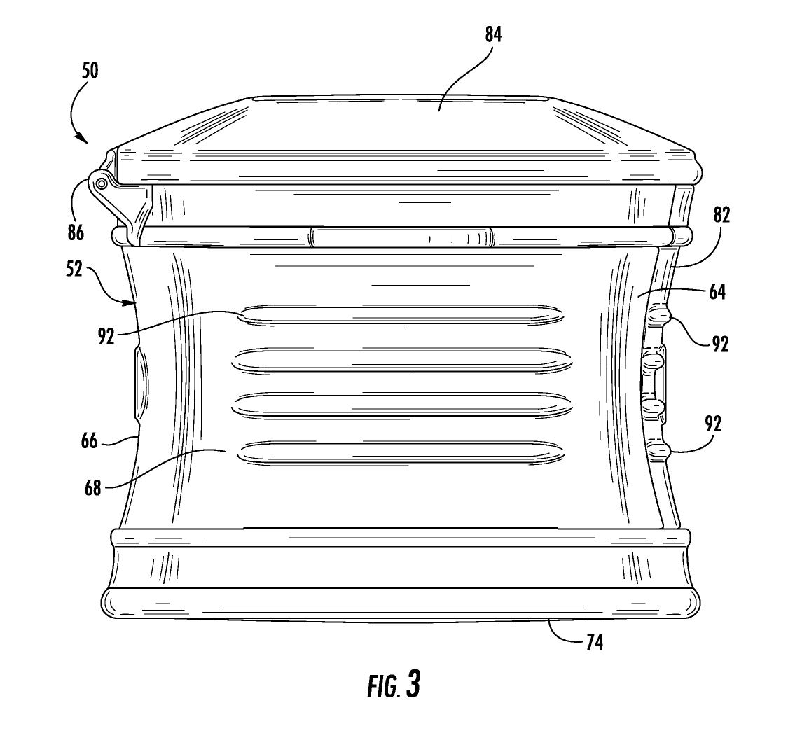

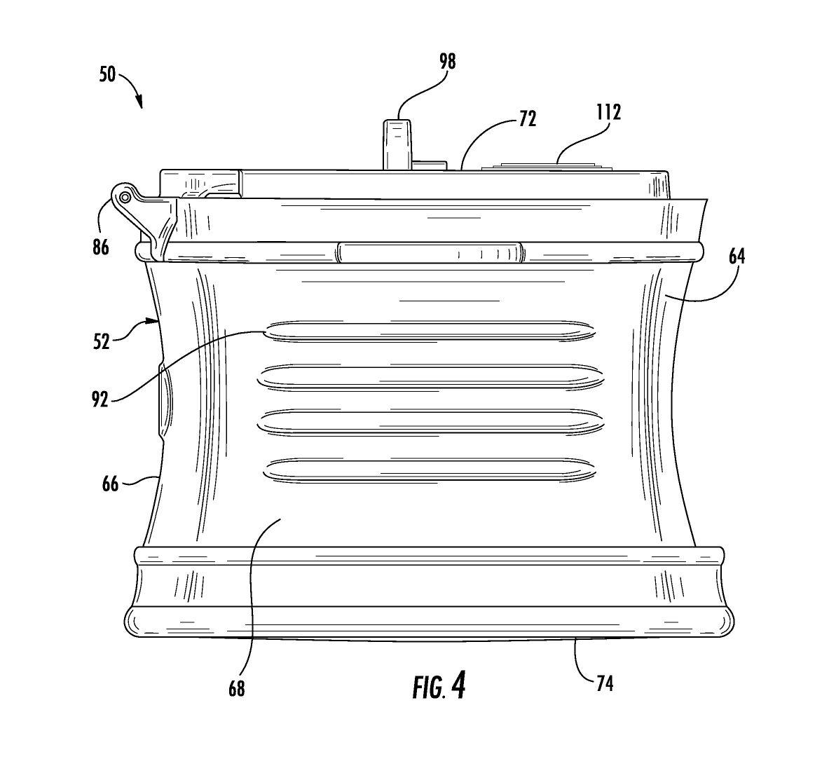

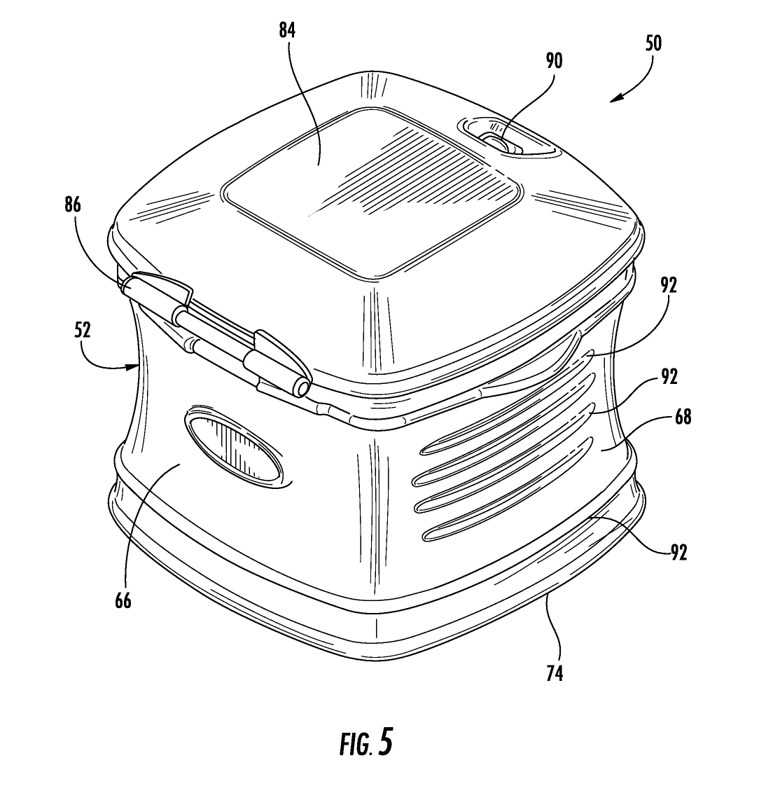

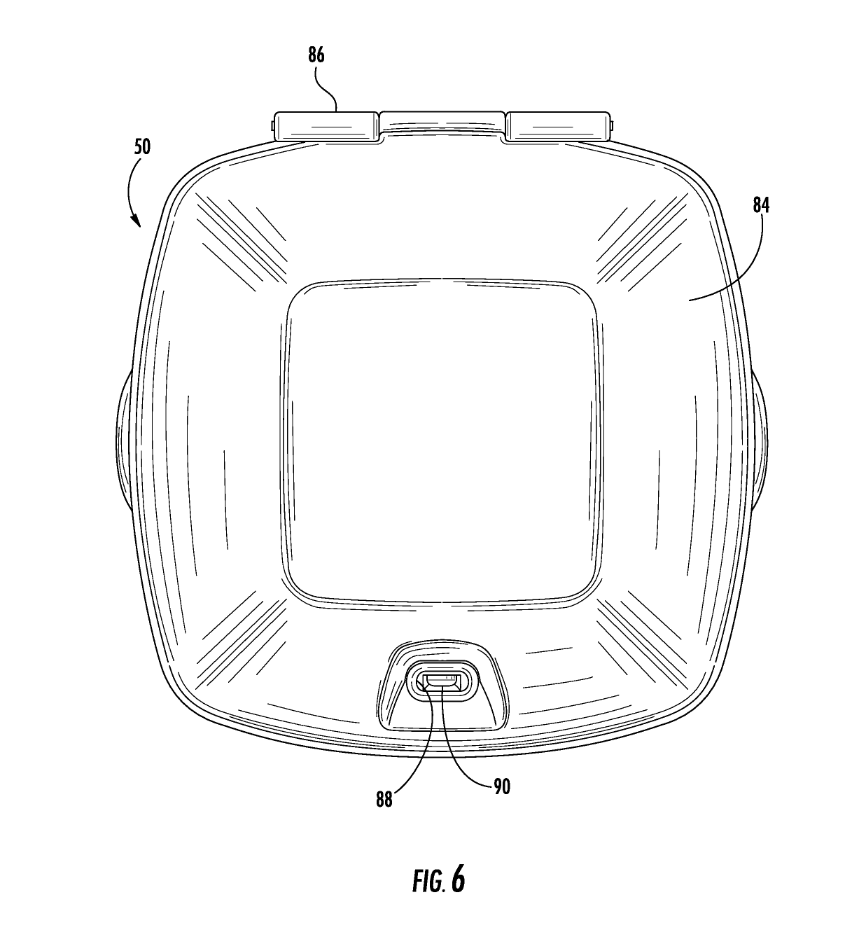

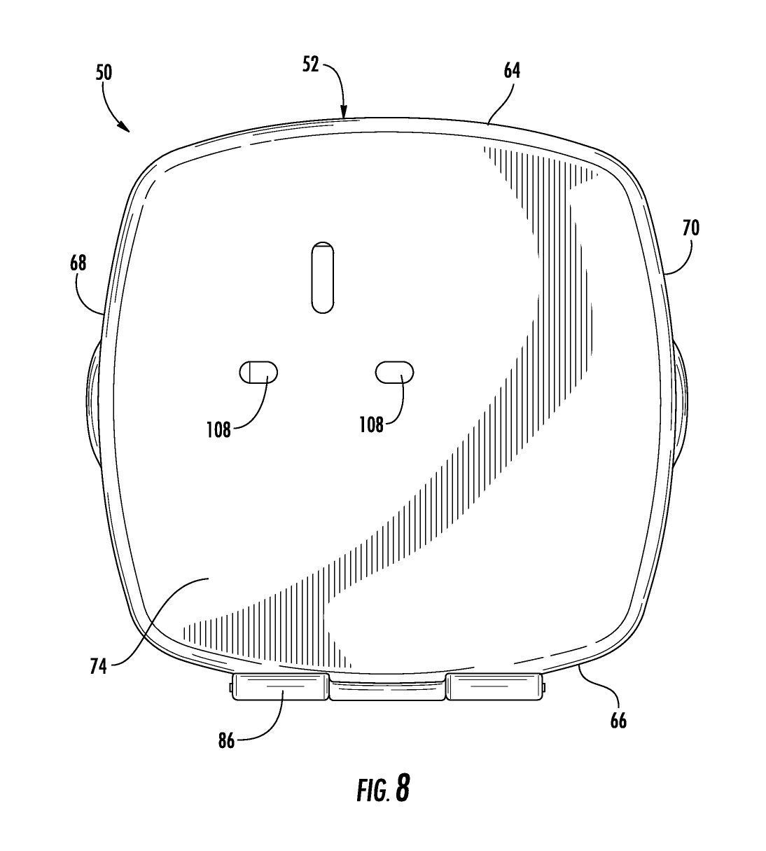

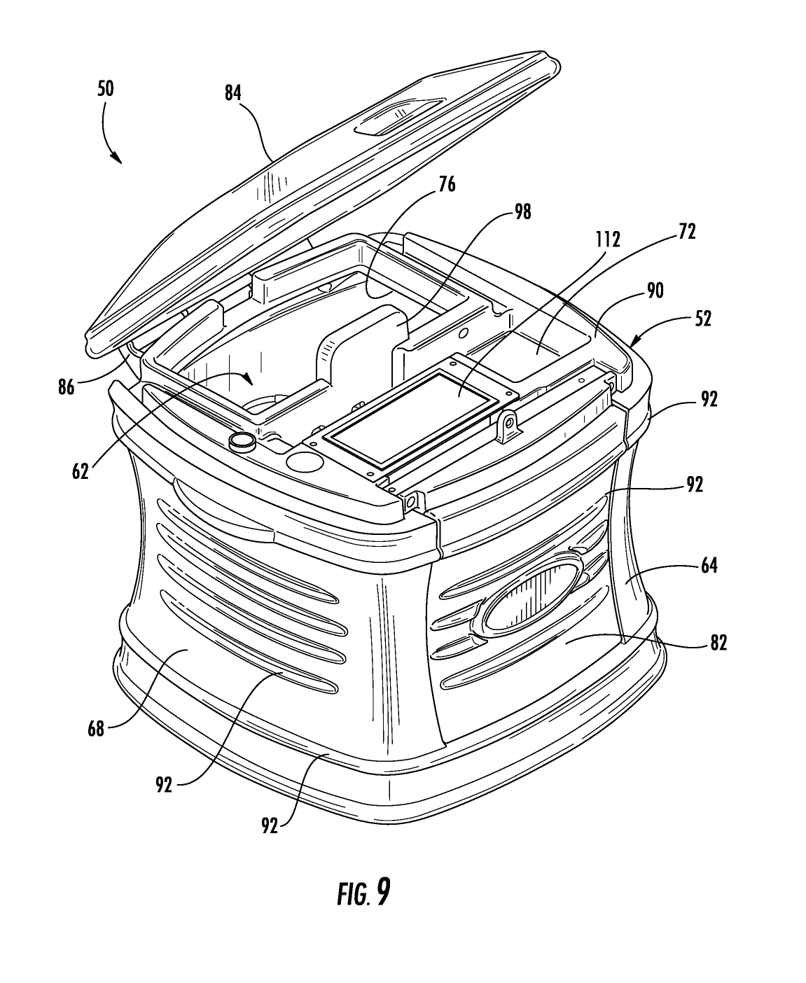

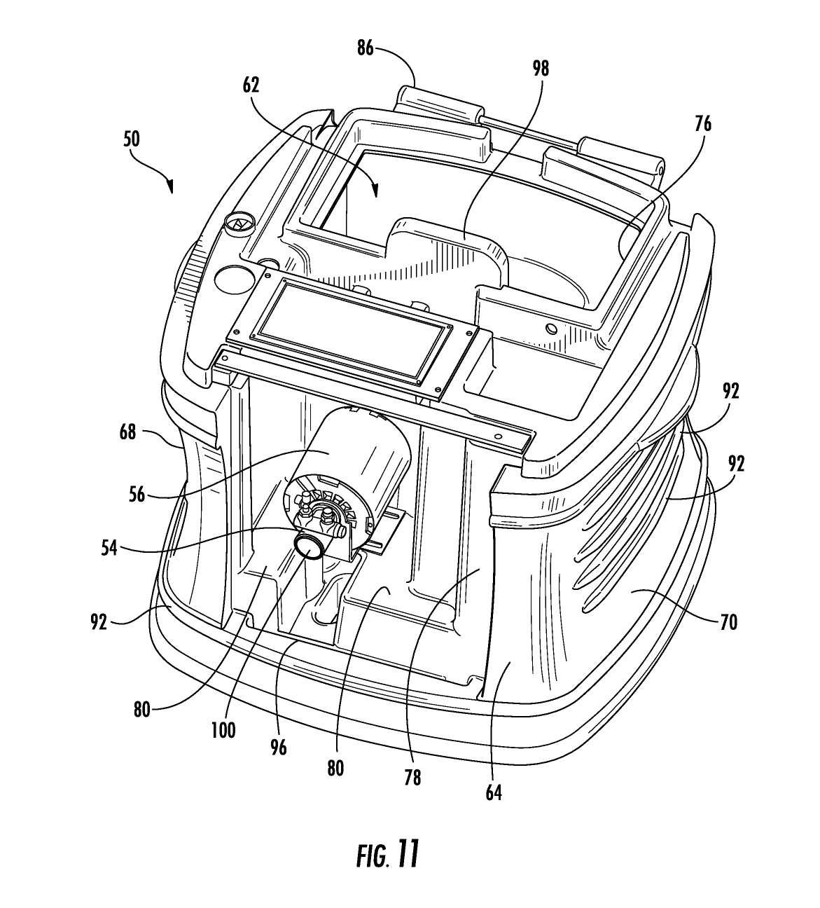

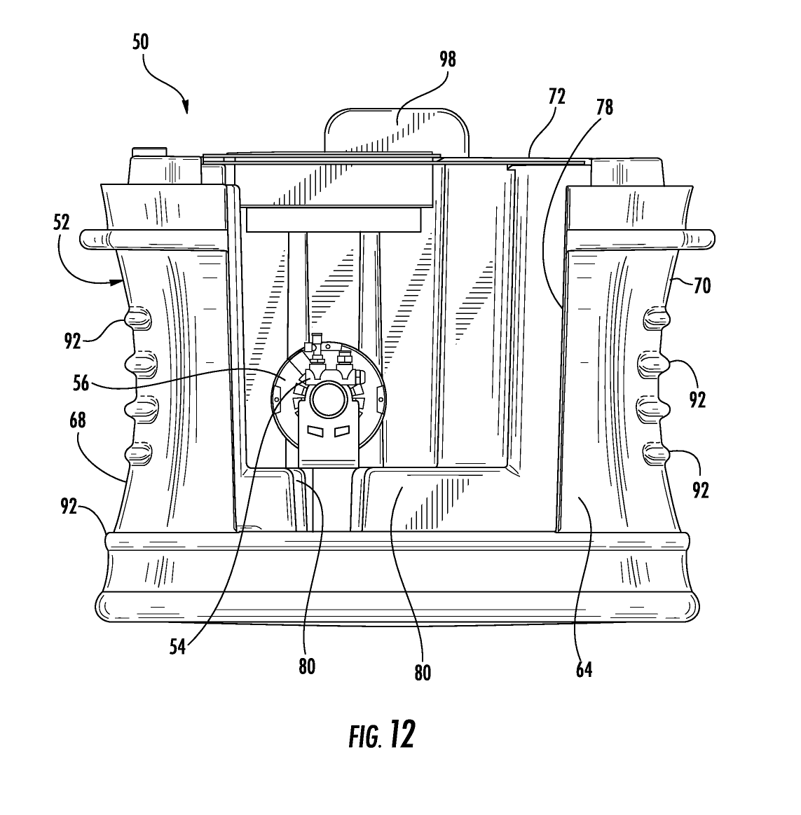

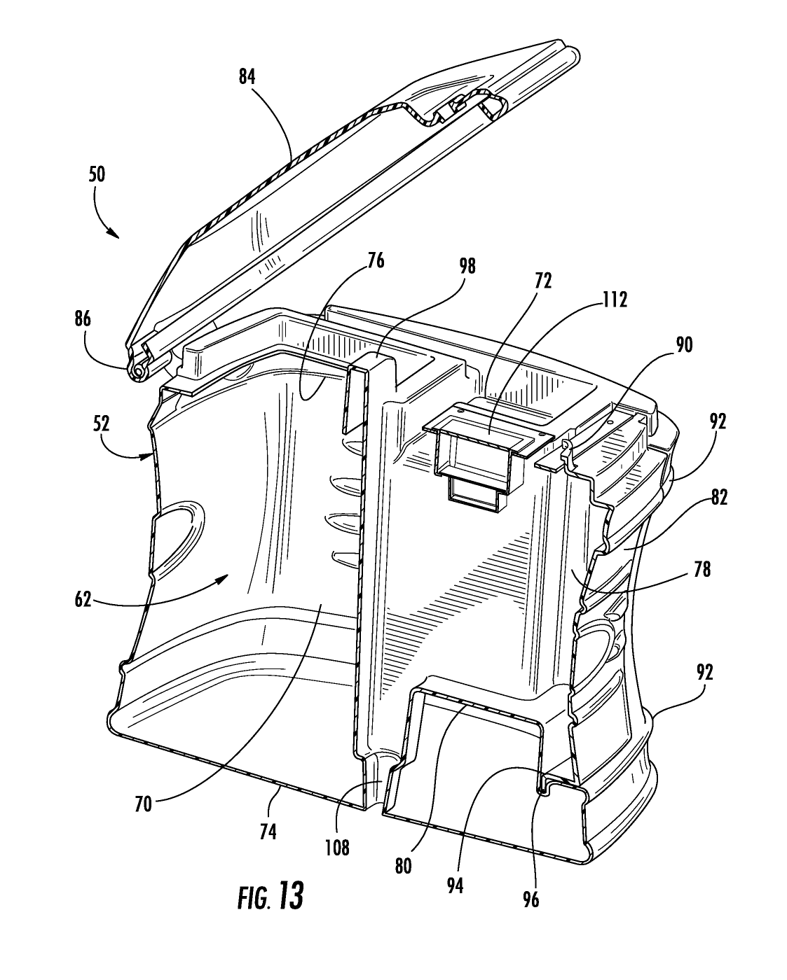

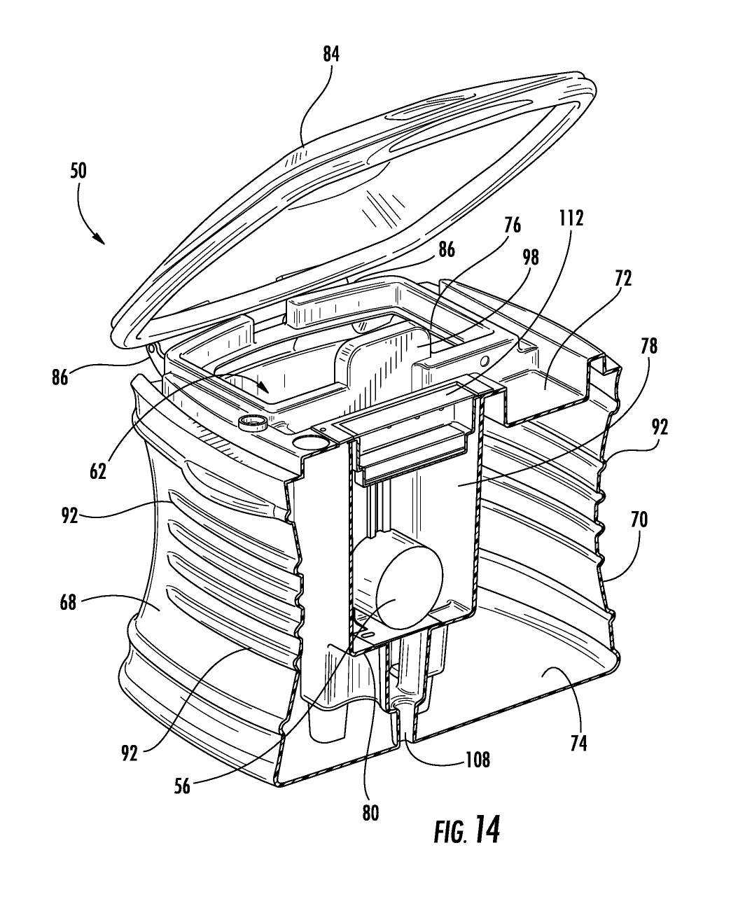

Referring now to FIGS. 1-14, wherein like reference numbers refer to like or similar elements throughout the several views, there is shown an apparatus for delivering a fluid as a spray and generally designated at 50. The spray delivery apparatus 50 comprises a fluid holding tank 52, a pump 54 operatively coupled to a motor 56 for drawing the fluid via a supply line 58 from the tank 52, and a distribution system (not shown) in fluid communication with the pump 54, the distribution system including conduit for delivering the fluid to a plurality of remote locations, such as a spray nozzle circuit. A programmable controller 60 is used to control the pump 54 for determining the frequency and duration of fluid dispersal via the spray nozzles.

The tank 52 comprises an integrated, rhombus-shaped structure defining a fluid reservoir 62 for containing a liquid insecticide. The fluid reservoir 62 is defined by a front side wall 64, a back side wall 66, a right side wall 68, and a left side wall 70. A partial top wall 72 and a bottom wall 74 extend between and interconnect the side walls 64, 66, 68, 70. The tank 52 is closed on all sides and the bottom. The top wall 72 defines an opening 76 for receiving fluid. The front side wall 64 of the tank 52 defines a vertically extending recess 78 for accommodating the pump 54, the motor 56 and the controller 60. Two opposed buttresses 80 on the front wall 64 extend inwardly forming a platform for supporting the pump 54 and motor 56. Threaded inserts are provided through the buttresses 80 for receiving threaded fasteners for mounting the pump 54 and the motor 56 to the tank 52. A removable front access panel 82 is configured to cover the recess 78.

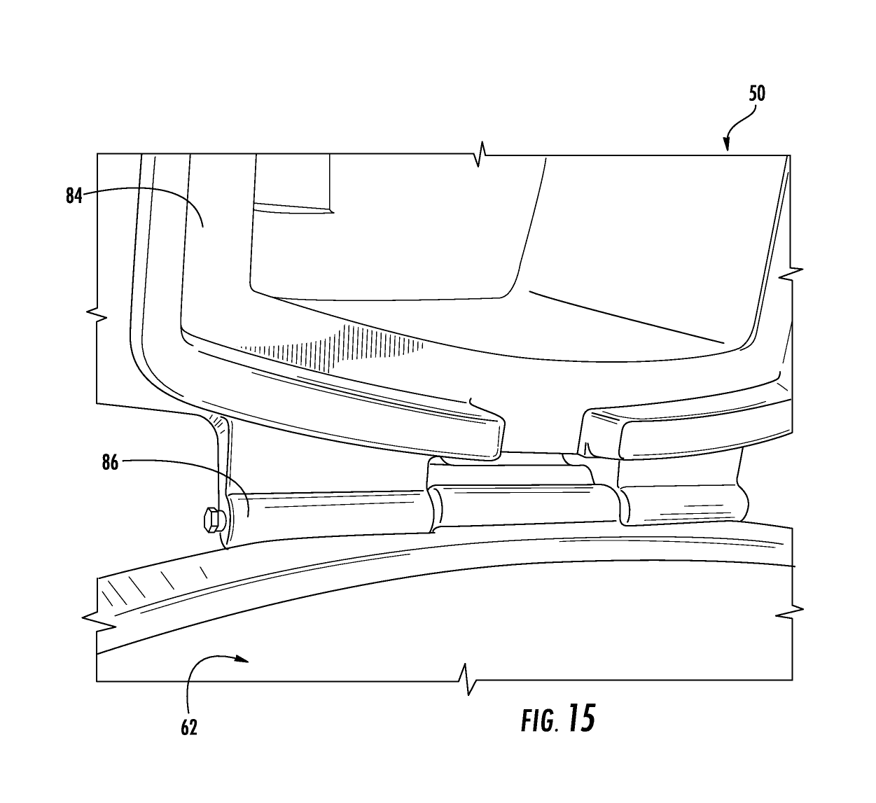

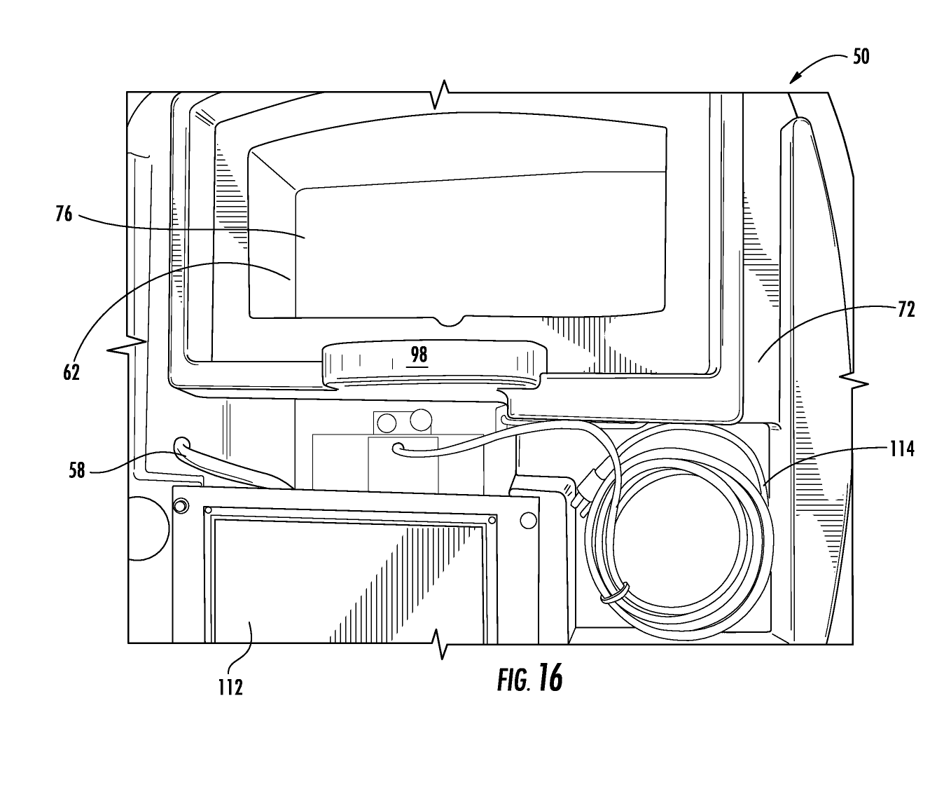

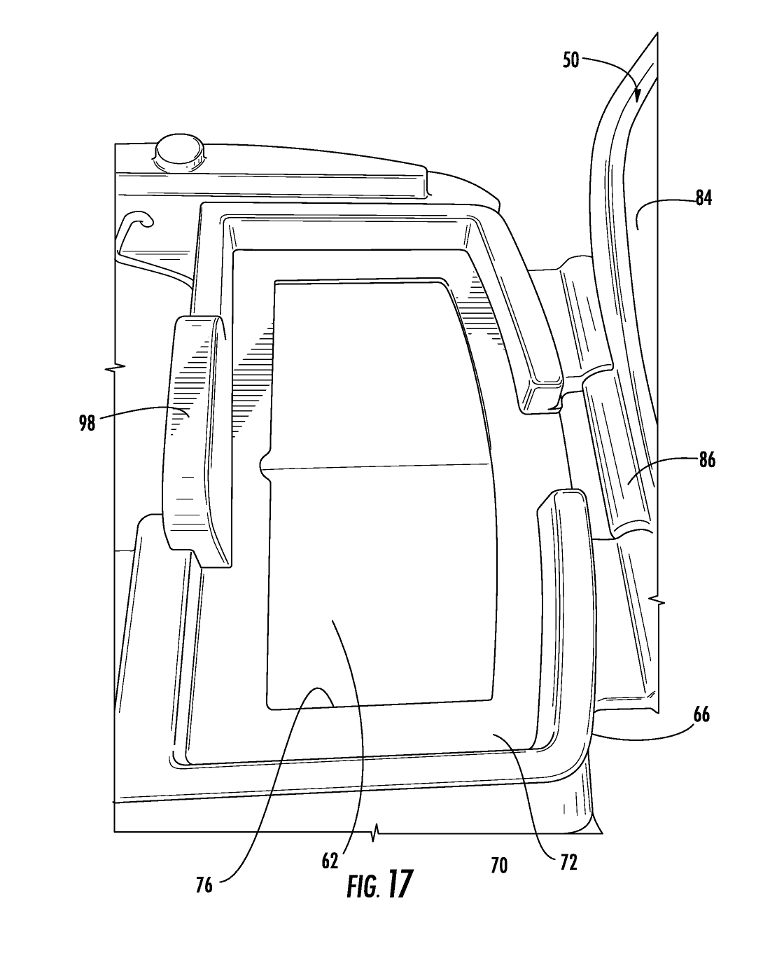

A lid 84 is attached by a mechanical hinge 86 to the back side wall 66 of the tank 52 (FIG. 15). The lid 84 is configured such that the edge of the lid, when in the closed position, overhangs all of the side walls 64, 66, 68, 70 of the tank 52 and prevents weather and moisture from accessing the interior of the tank. The lid 84 provides the user with access to the interior of the tank 52 by pivoting the lid. Fluid can be added to the fluid reservoir 62 via the opening 76 in the top wall 72. A removable transparent plastic cover 85 fits over the opening 76. The cover 85 functions to minimize condensation, moisture, etc. (FIG. 16). The lid 82 defines a small slot 88 along a front edge for receiving a tab 90 on the upper edge of the access panel 82 when the lid is in a closed position (FIG. 17). The tab 90 has a hole for receiving a locking means, such as a padlock (not shown).

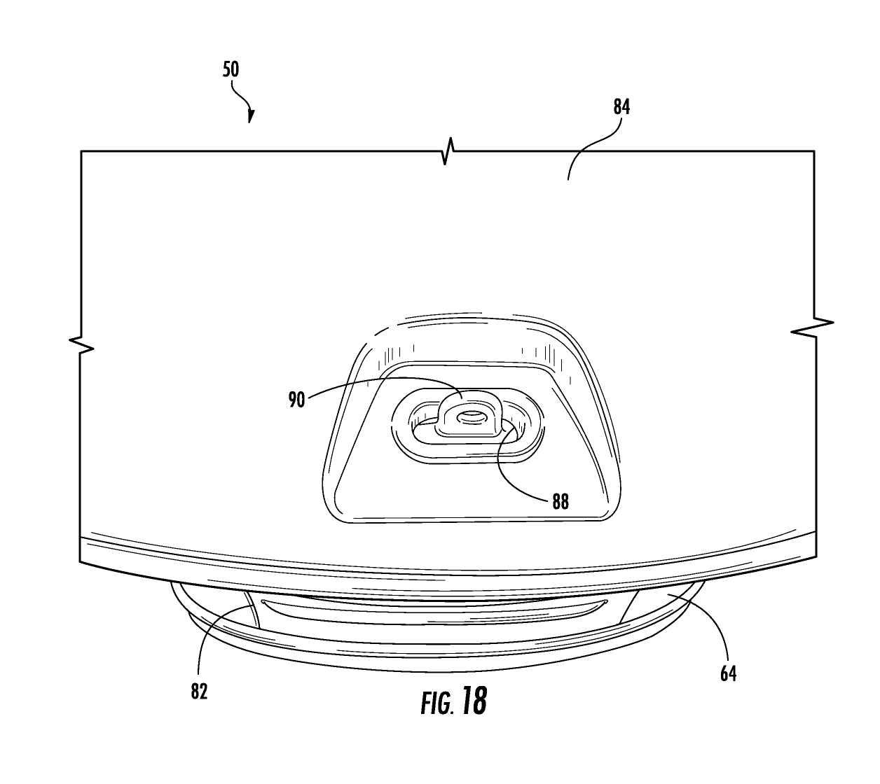

The tank 52 and lid 84 may be formed from a durable plastic material sufficient to withstand weathering, ultraviolet rays and be resilient enough to maintain the strength necessary to hold a predetermined volume of fluid and related components. The preferred material is high density polyethylene or other suitable material. As shown in FIGS. 1 and 3-6, the side walls 64, 66, 68, 70 are concave in order to bear fluid pressure caused by the weight of the fluid. The side walls 64, 66, 68, 70 further comprise integral horizontal ribs 92 to add rigidity and strength to the tank 52 (FIG. 18). The configuration of the tank 52 also allows for some expansion due to fluid pressure. It is understood that other suitably strong and durable materials may be used, such as rust-resistant metals, fiberglass, and the like.

The tank 52 is a suitable size and volume to contain a desired amount of fluid. Preferred tank sizes hold, for example, 30 gallons, 60 gallons, 120 gallons, and 225 gallons. In one embodiment holding 60 gallons, each side wall 64, 66, 68, 70 of the tank 52 is approximately thirty four inches long and the tank 52 stands twenty nine inches tall. Selection of the size of tank 52 depends upon the size of the area to be protected by the system, length of conduit in the distribution system, the number of nozzles, and frequency of use.

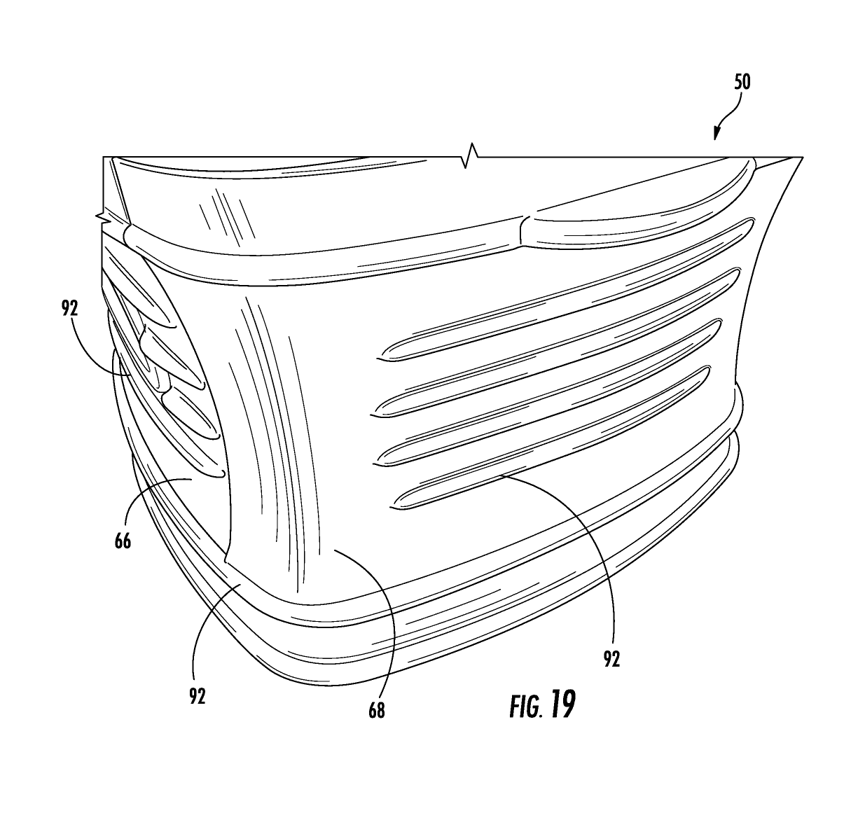

The access panel 82 is a generally rectangular piece formed from the same material as the tank 52 (FIG. 19). The lower end of the access panel 82 includes a flange 94 configured to be inserted into a slot 96 in the front side wall 64 of the tank 52. The access panel 82 fits between opposed outer vertical portions of the front side wall 64 through the use of simple friction or force fit tolerances. The access panel 82 provides protection to the pump 54, motor 56 and the controller 60 from contamination, weathering and moisture, as well as acting as a safety barrier. The front side wall 64, lid 84 and access panel 82 together define a weather-resistant protective receptacle.

The tank 52 includes a center post 98 integral with the front side wall 64 that extends upwardly for supporting the center of the lid 84. The buttresses 80 and the center post 98 extend vertically to the bottom wall 74 for providing strength and support to the tank 52.

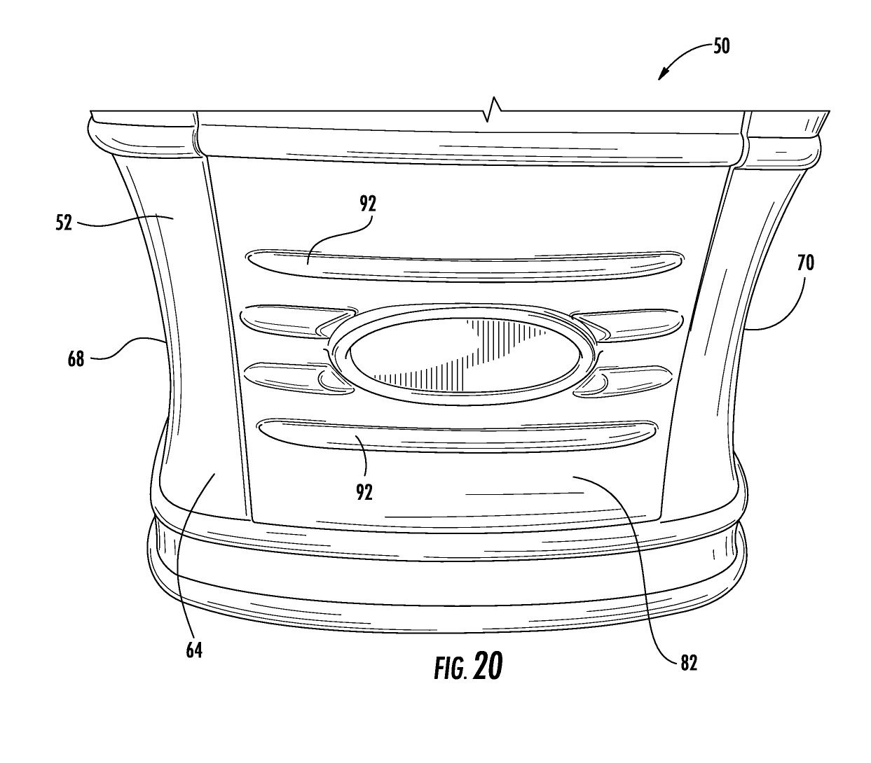

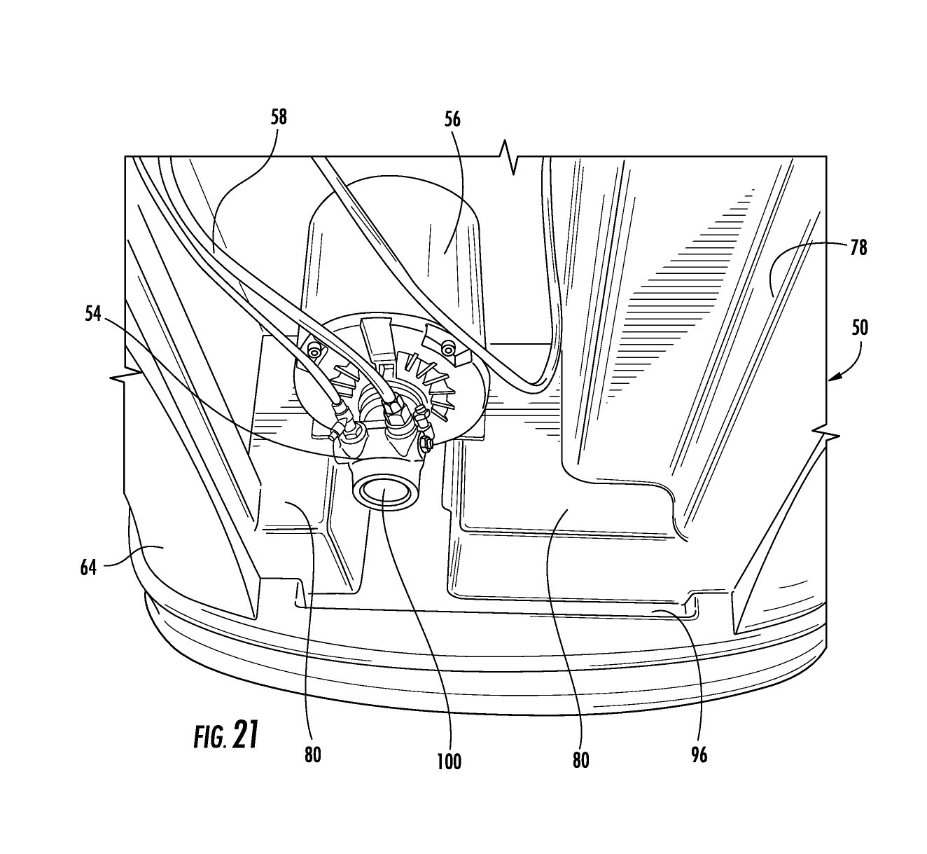

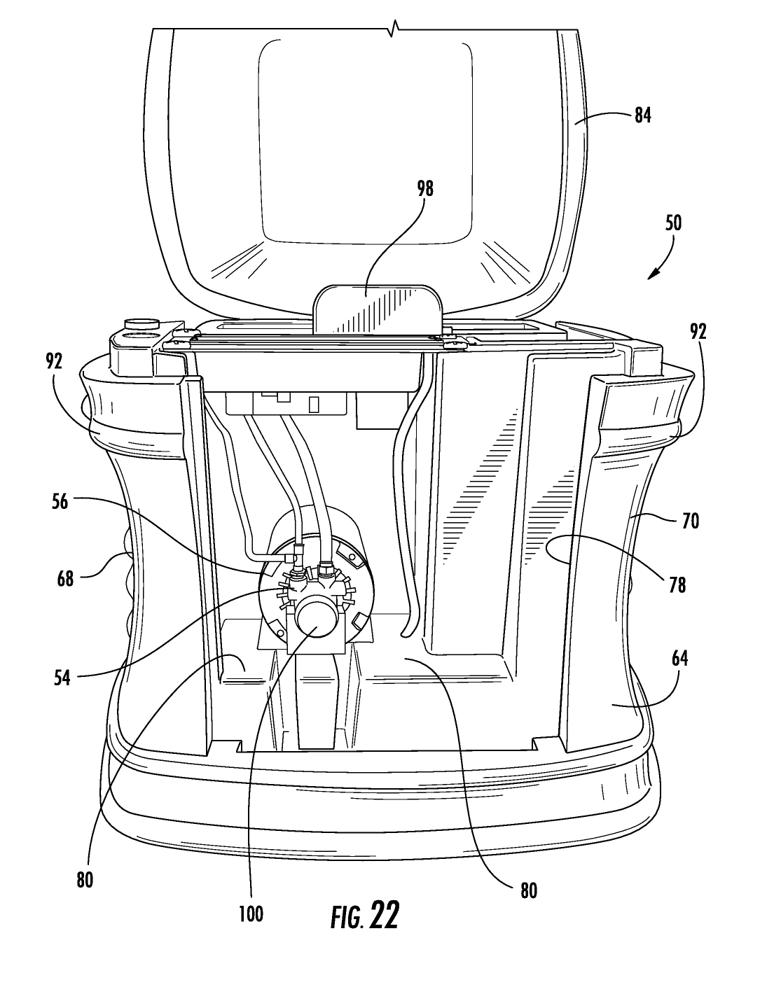

The pump 54 is mounted in the recess 78 formed in the front side wall 64 of the tank 52 (FIGS. 20 and 21). A pump suitable for use in this application delivers from about 100 gallons per minute to about 115 gallons per minute at from about 180 PSI to about 220 PSI. The pump 54 has a fitting 100 including a fluid inlet 102 that is connected to one end of the flexible supply line 58. The other end of the supply line 58 passes through an opening in the front side wall 64 and downwardly into the fluid reservoir 62 to adjacent the interior bottom of the tank 52. A coarse particle filter screen 104 (not shown) is secured over the lower end of the supply line 58 for screening out large particles and sediment. The pump 54 is operated by an appropriate electric motor 56, for example, a 120V GE motor (FIG. 22). The motor 56 is, in turn, operatively connected to a power source and communicating with the controller 60, such that the actuation of the motor 56 is determined in accordance with the operational method described hereinafter. The fluid outlet 106 of the pump fitting 100 is connected to a fluid conduit (not shown) that extends from the pump to a plurality of fluid-dispensing nozzles disposed at preselected intervals or distances along the conduit for application to a remote target.

The pump 54 and the motor 56 are mounted on the buttresses 80 in the recess 78 in the front wall 64. The pump 54 and motor 56 are adjacent the reservoir 62 below the upper fluid levels. This arrangement eliminates dead volume and allows the tank 52 configuration to be more low profile, and also provides some head pressure to the pump 52. In addition, the weight of the motor 56 is translated through the buttresses 80 which bear the weight to the ground. Drain channels 108 on each side of the recess 78 facilitate drainage of any fluid which might enter the recess 78.

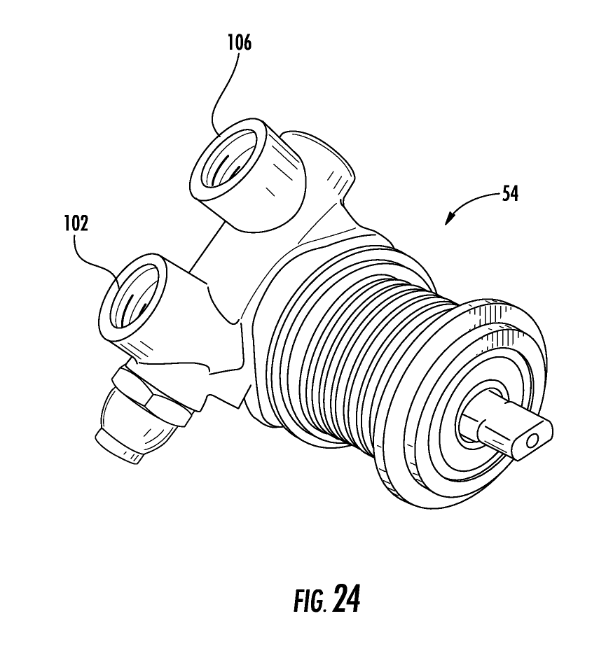

The spray delivery apparatus 50 further comprises at least one float switch 110 (FIG. 24) disposed in the fluid reservoir 62 for detecting the level of fluid remaining in the fluid reservoir. The float switch 110 provides a signal via wiring to the controller 60 that is indicative of the fluid level, causing the pump 54 and motor 56 to shut off when the fluid volume drops to a certain predetermined minimum level. The float switch 110 thus prevents power from being provided to the motor 56 until fluid is added to the fluid reservoir 62.

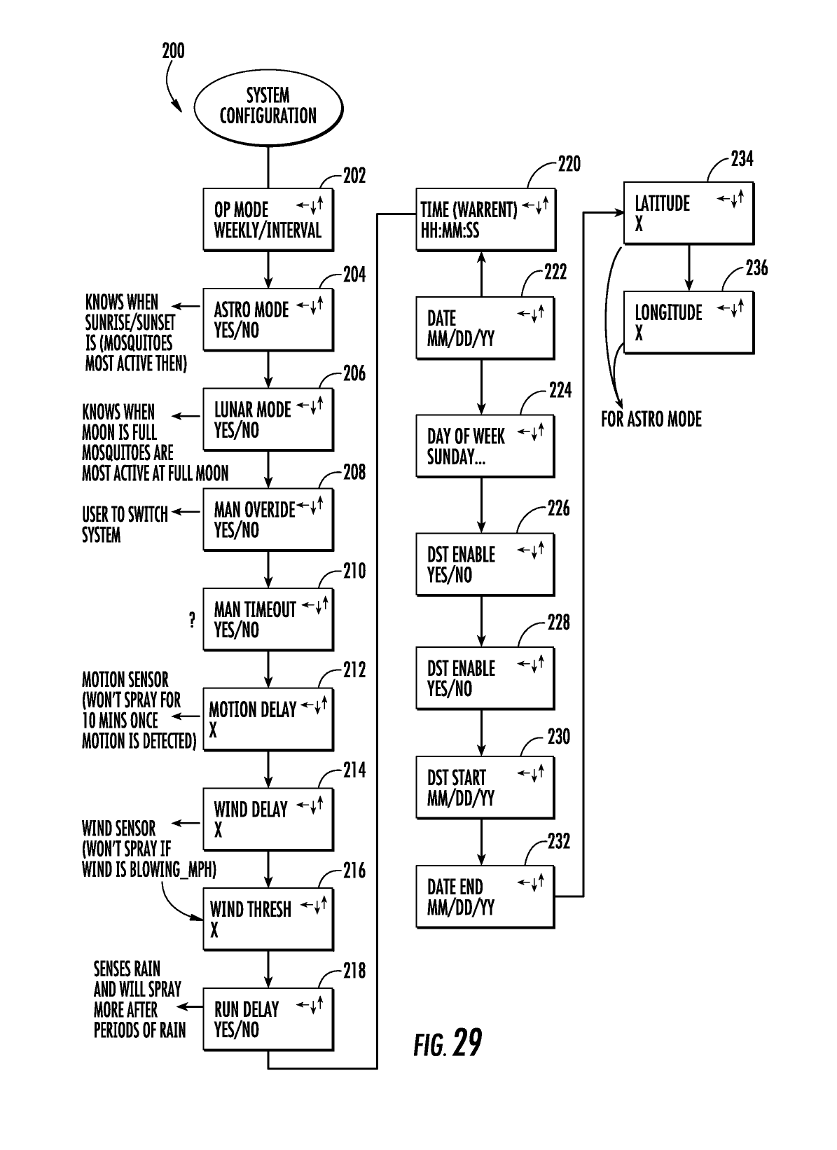

Other sensors may be used and interconnected with the controller 60 to regulate the operation of the spray delivery apparatus 50. Referring to FIG. 29, a weather sensor, such as a rain sensor 218, may be provided. The rain sensor 218 detects moisture levels in the atmosphere and determines the presence of rain. At high moisture levels or in the case of rain, the controller 60 will spray more frequently or for longer durations to coincide with increased mosquito activity after rain. One or more motion detectors may also be interconnected with the controller for preventing spraying for a period of time after motion is detected in the spray area 212. Another environmental sensor is a wind sensor. The controller 60 will query whether spraying should be delayed 214 if a minimum wind threshold 216 is exceeded.

The spray delivery apparatus 50 is suitable for applying fluid comprising various chemicals. The term “chemical” as used herein includes both liquids and dry flowables. Almost any kind of fluid could be applied with the apparatus 50, except those which would attack the material of the tank 52. It is particularly suitable for mosquito and other pest control situations. For example, suitable liquid insecticide can be a safe, natural insecticide such as Pyrethrum, a Chrysanthemum extract. The spray delivery apparatus 50 could also be used in horticultural applications to apply liquid fertilizers, herbicides and fungicides. Micro-encapsulated spheres in liquids can also be applied.

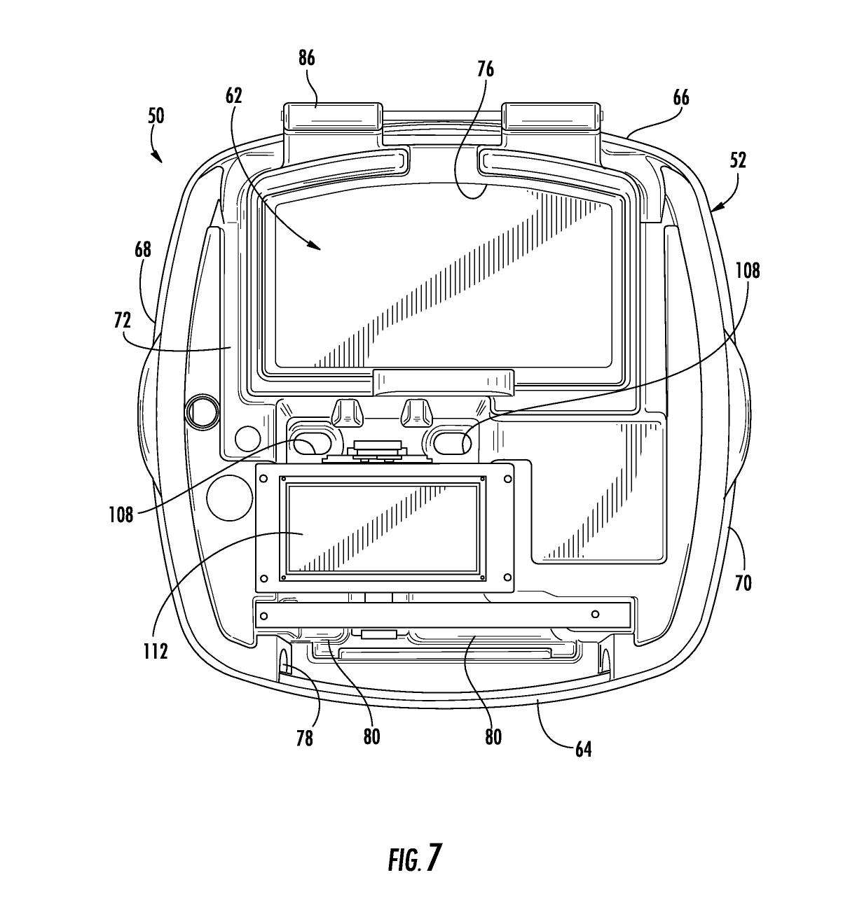

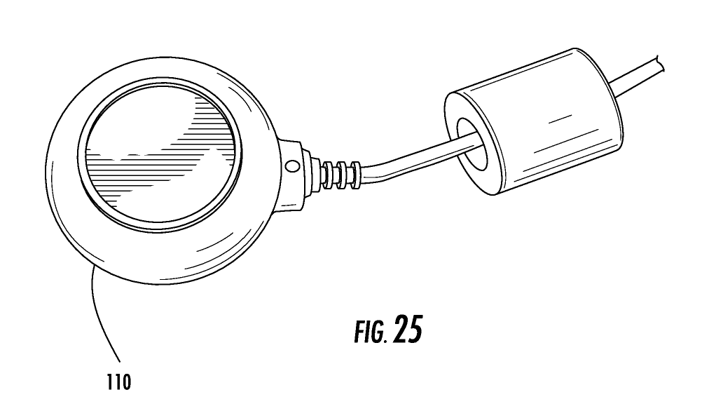

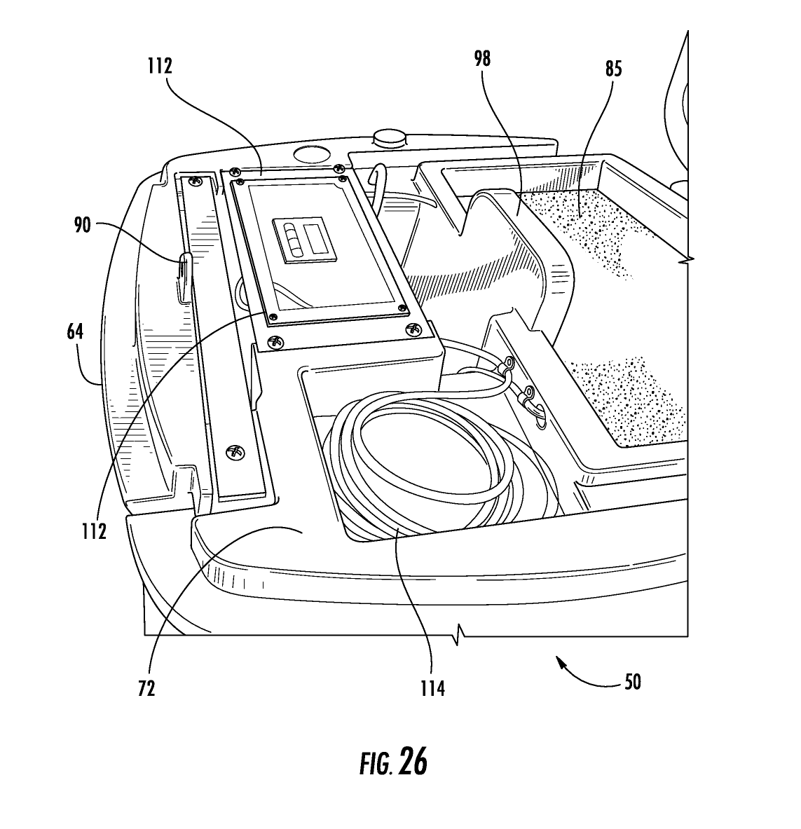

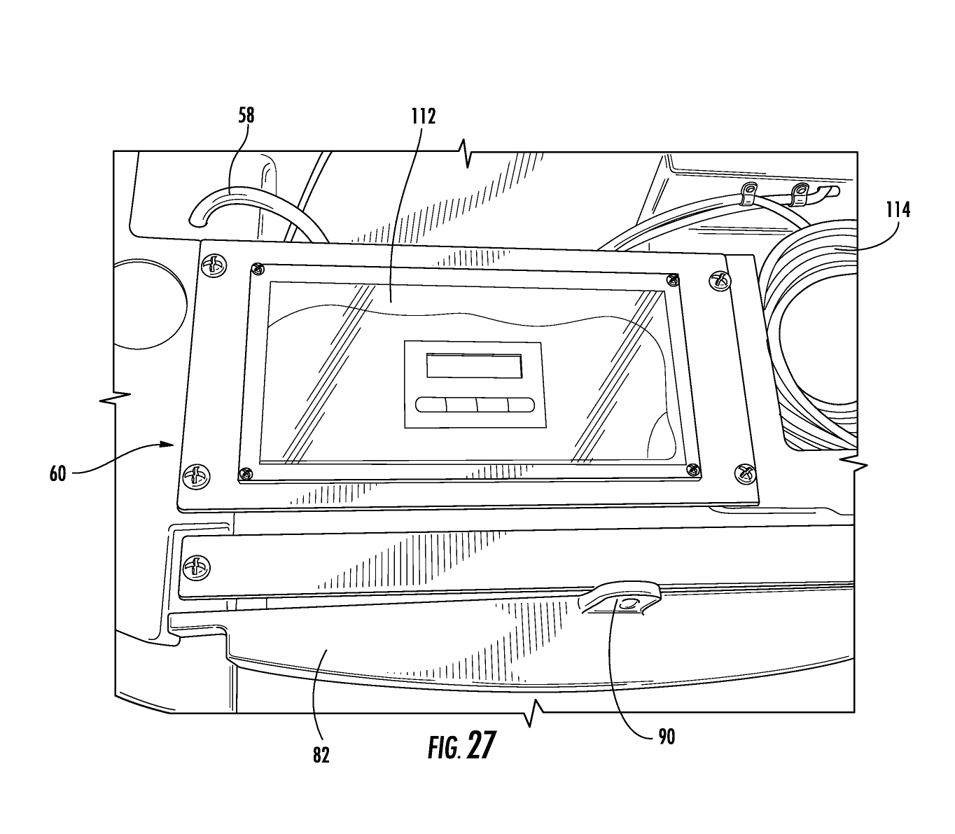

As shown in FIGS. 7, 9, 11 and 27, the controller 60 is mounted atop the buttresses 80 in the front side wall 64 of the tank 52 above the pump 54 and motor 56 (FIGS. 25 and 26). Operation of the spray delivery apparatus 50 is determined by the controller 60. The controller 60 comprises a programmable digital processor, data storage media, a timer and other elements necessary for the operation of the apparatus 50 in a manner that will be described. Programming of the processor may be performed by one of skill in the art who is provided with the functional requirements of the physical components of the system. The data storage media is used to store user input parameters, such as the times, frequency and duration of spray cycles. The controller 60 is interconnected with the float switch 110 and other sensors for transmitting and receiving impulses to and from the controller 60. The controller 60 thus serves not only as a timer for length of time of discharge and frequency, but also as a controller responding to readings from the sensors to assure that all functions of the apparatus 50 are performed within prescribed parameters.

In one embodiment, the programmable processor of the controller 60 communicates with a user interface display panel 112. The display panel 112 may include a window providing a graphic indication of the sensed parameters, such as the level of fluid remaining in the fluid reservoir 62. The display panel 112 also provides a control interface used for operation of the controller 60. A user accesses the features of the controller 60 via the control interface, such as a keypad, and information is displayed to the user on the display panel 112. The control interface may include a number of programming buttons that enable a user to select among a number of pre-programmed control parameters for the system. During programming of the controller 60, the display panel 112 is used for programming among selectable control parameters which include, for example, frequency of spray cycles, remote control cycles, remote control counter, time of day for a given spray, the duration of spray during a spray cycle, and the like. Additionally, the controller 60 may report to the user the current fluid level and whether a low fluid level condition exists in response to the float switch 110. Using the control buttons, the user may select to turn on, or turn off, any aspect of the system manually, or engage the controller 60 to operate the system automatically according to its preprogrammed instructions.

A manual control may be used to override the automated, preprogrammed operation of the fluid delivery apparatus 50. For example, a user may wish to initiate a spray cycle outside of the automated timing for such sprays. The user may do this by actuating the manual control to immediately start spraying 208 (FIG. 29). A user might also desire to cancel a current spray cycle using the manual control as an override 210. The manual control thus allows a user to apply a selected amount of fluid at a selected time. The manual control can be attached to the apparatus 50, or the manual control may be physically located remotely from the spray delivery apparatus 50 and function through the use of radio frequencies instead of wires.

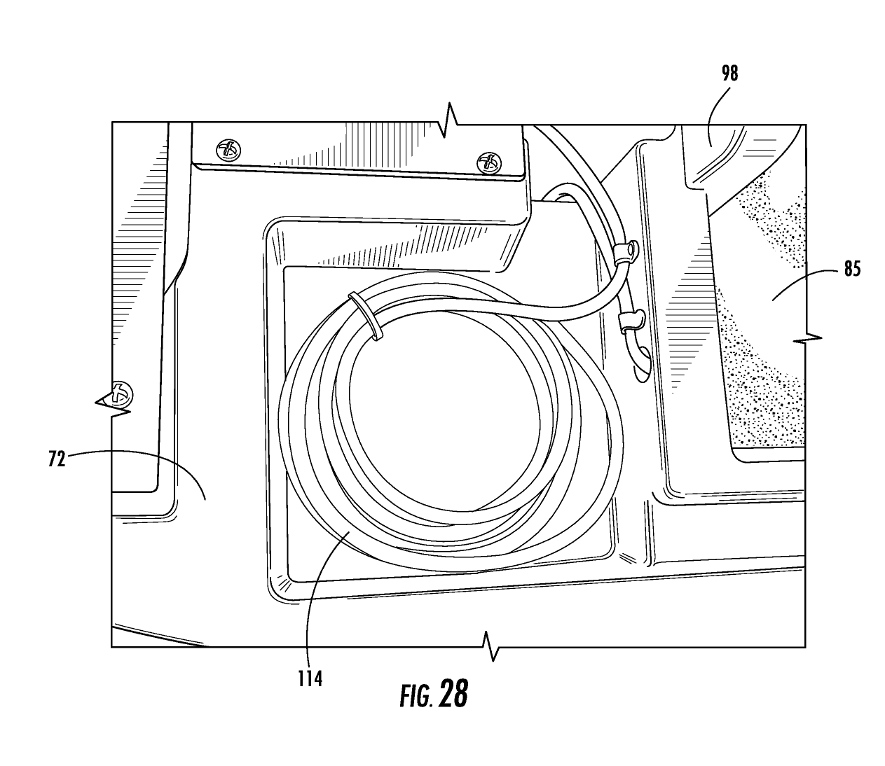

The fluid delivery apparatus 50 preferably draws power from an AC electrical power source. A power cord 114 (FIG. 28) extends outwardly from the tank 52 for this purpose. The power cord 114 is preferably a standard 120 volt outlet plug that may be used in typical residential outlets. An opening through the tank 52 is provided above the waterline for passing the power cord 114. Backup power may be supplied via a battery (not shown) to preserve user settings in the event that AC power fails. Motor overload protection can also be used to monitor the amp load on the motor and shut down the motor if the amp load is too high.

In use, the fluid reservoir 62 is filled with a fluid that may contain, for example, an insecticide. When the motor 56 is actuated, negative pressure is created by the pump 54 in the supply line 58, which causes the fluid to move up the supply line 58 to the inlet 102 of the pump fitting 100. The fluid then passes through the pump 54 and through the outlet 106 of the fitting 100 and into the conduit for application through the distribution system.

The controller 60 is operably interconnected via control wiring with the pump 54, the motor 56 and the float switch 110. The spray delivery apparatus 50 may be actuated by the controller 60 to operate based on a timer to operate for a predetermined cycle at a predetermined frequency, for example, 60-second fluid distribution cycles every 30 minutes. The controller 60 may also be adjusted, or set, to operate on any cycle, depending upon the needs of the user. The controller 60 may, for example, be programmed to operate the pump for a 3 minute cycle every 60 minutes, or it may be programmed for a 20 second cycle every 3 hours. In an “astro mode” 204 (FIG. 29), the cycle may be based on an astronomical timer and also take into account sunrise and sunset, spraying more at those times when mosquitos are more active. The controller 60 will receive the location of the tank 52 based on the latitude and the longitude input into the controller during setup. Similarly, in a “lunar mode” 206, spraying frequency is increased during a full moon when mosquito activity increases. For example, the system may add an additional spray cycle at 2 a.m. three days before and three days after a full moon. In any event, the operation of the timer actuates the motor 56 for the pump 54, which in turn draws fluid from within the tank 52 through the supply line 58. It is understood that the controller 60 may be programmed for a plurality of spraying intervals in any given period, for example, 24 hours. Each spray interval may have a duration ranging from 1 second to several minutes of hours.

An embodiment of a system configuration 200 for automatic operation of the spray delivery apparatus 50 is depicted in the flow chart of FIG. 29. Initially, the user inputs the time in step 220, the date in step 222 and the day of the week in step 224. In step 226, the controller 60 queries the timer to determine if it is time to enable a new spray cycle. If not, the controller takes no action in step 228. Otherwise, the controller 60 queries the float switch 110 to determine whether the fluid in the reservoir 62 is at a minimum level. If so, the controller 60 cancels the spray cycle. If no such conditions are detected, the controller 60 then starts the motor 56 and the pump 54 in step 230. As described above, during operation the fluid is pumped through the supply line 58 from the fluid reservoir 62 and throughout the distribution system to each of the nozzles. When the controller 60 determines from the timer that the spray cycle should end, the controller 60 commands the motor 56 and the pump 54 to turn off in step 232, thereby preventing fluid transmission from the fluid reservoir 62. It is understood that the process is iterative. If the controller 60 does not detect further user input, the controller 60 compares the current time to the stored start time intervals to determine whether spraying of fluid should again commence. For example, if an interval end time has been reached, step 232, the controller 60 determines whether the user has manually overridden the system 208 to cause the system 200 to spray fluid.

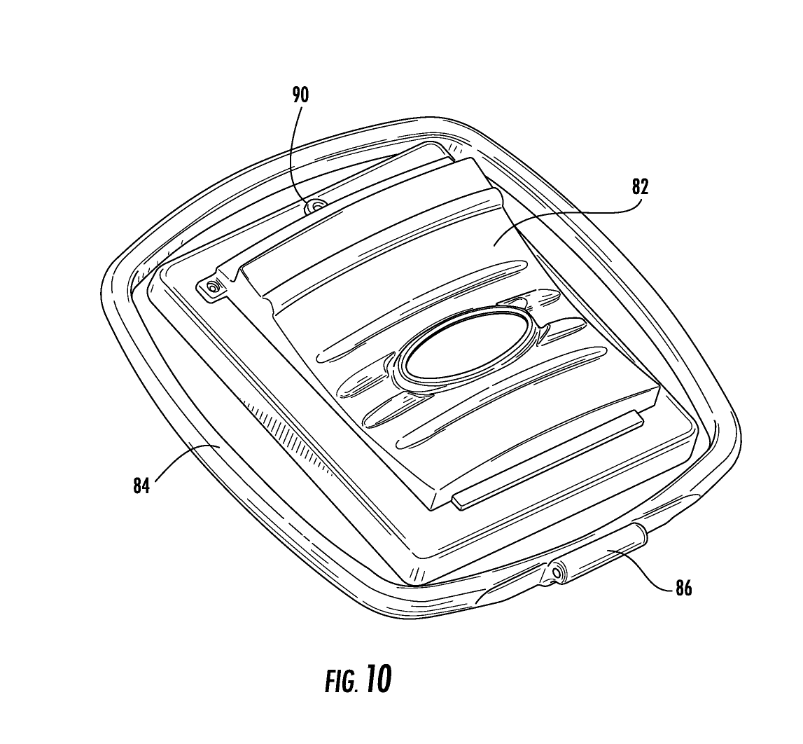

The spray delivery apparatus 50 may be manufactured in an injection mold or a rotation mold. In one embodiment, shown in FIG. 10, the front access panel 82 and the lid 84 are molded in one integral piece with the access panel 82 on the underside of the lid 84. The access panel 82 is subsequently trimmed out of the underside of the lid 84.

The spray delivery apparatus 50 has many advantages, including system operation utilizing a number of operational parameters. Sequencing of the parameters may be controlled by the user. Accordingly, a user achieves greater control and accuracy of insecticide distribution through the use of the programmable controller, which permits controlled spraying of insecticide. The efficiency of the targeted application decreases the amount of insecticide that needs to be applied to an area to control mosquito and other flying insects and pests population, such as the yard of a residential home, areas surrounding commercial buildings, animal husbandry facilities, and the like. In addition, over spraying of pesticide can be minimized since the system is not necessarily spraying at predetermined intervals.

The spray delivery apparatus 50 may be integrated into a mobile spray system and, in a further embodiment, is useful for spraying of other chemicals in addition to insecticides.

Although the apparatus and method for fluid delivery has been shown and described in considerable detail with respect to only a few exemplary embodiments thereof, it should be understood by those skilled in the art that we do not intend to be limited to the embodiments since various modifications, omissions and additions may be made to the disclosed embodiments without materially departing from our novel teachings and advantages, particularly in light of the foregoing teachings. Accordingly, we intend to cover all such modifications, omission, additions and equivalents as may be included within the spirit and scope of the invention as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

We claim:

1. An apparatus for delivering a mist from a fluid, the mist delivering apparatus comprising:
a housing defining a reservoir for accommodating the fluid;
a pump in fluid communication with the reservoir for drawing fluid from the reservoir;
a fluid distribution system in fluid communication with the pump for transmitting fluid from the pump; and
a controller including a programmable digital processor for selectively operating the pump according to predetermined control parameters.

2. The mist delivering apparatus as recited in claim 1, further comprising a level sensor including a float disposed within the reservoir, the level sensor providing a signal to the controller indicative of the level of fluid within reservoir.

3. The mist delivering apparatus as recited in claim 1, wherein the fluid is an insecticide.

4. The mist delivering apparatus as recited in claim 1, wherein the fluid is a pesticide.

5. The mist delivering apparatus as recited in claim 1, wherein the fluid is an insect repellant.

6. The mist delivering apparatus as recited in claim 1, further comprising a moisture sensor for detection of rain proximate the housing, the moisture sensor operably associated with the controller so that detection of rain will effect a spray cycle.

7. The mist delivering apparatus as recited in claim 1, wherein the fluid distribution system comprises a misting nozzle for dispersal of fluid.

8. The mist delivering apparatus as recited in claim 1, wherein the controller includes a timer.

9. The mist delivering apparatus as recited in claim 8, wherein the predetermined control parameters include a timed cycle for operation of the pump.

10. The mist delivering apparatus as recited in claim 8, wherein the controller monitors sunrise and sunset for affecting a spray cycle.

11. The mist delivering apparatus as recited in claim 8, wherein the controller monitors a lunar cycle for affecting a spray cycle.

12. The mist delivering apparatus as recited in claim 1, further comprising a remote control for operation of the controller.

13. The mist delivering apparatus as recited in claim 1, further comprising a transmitter for transmitting information to a remote monitoring location.
